(19) United States
(12) Patent Application Publication
(10) Pub. No.: US 2026/0284922 A1
(43) Pub. Date: Sep. 24, 2026

(54) CUTTING SYSTEM FOR A SHEET OF PLASTIC MATERIAL

(71) Applicant: COLINES S.P.A., Novara (IT)

(72) Inventor: Vanni ZACCHE', Novara (IT)

(21) Appl. No.: 19/564,077

(22) Filed: Mar. 11, 2026

(30) Foreign Application Priority Data
Mar. 18, 2025 (IT) 102025000005475

(51) Int. Cl. B26D 7/08; B26D 1/06; B26D 7/01

(52) U.S. Cl. CPC B26D 7/086; B26D 1/065; B26D 7/015

(57) ABSTRACT

A cutting system is for a sheet of multilayer plastic material, and in particular a sheet of multilayer plastic material with an alveolar sandwich structure. Cutting equipment for the sheet of plastic material includes a cutting member which includes a cutting device coupled to a carriage sliding with reciprocating motion transversely to an advancement direction of a strip of the plastic material. The cutting device is placed on a tiltable support. The cutting device is an ultrasonic cutting device including a first sonotrode and a second sonotrode, connected to respective piezoelectric transducers and coupled along a straight line transverse to the advancement direction of the strip of plastic material. The first and second sonotrodes are inclinable by a predetermined angle and are positionable alternately so that one sonotrode is in an upper position and the other sonotrode is in a lower position, or vice versa.

### CROSS REFERENCE TO RELATED APPLICATIONS

The present application claims priority to Italian Patent Application No. 102025000005475 filed on Mar. 18, 2025, which application is incorporated herein by reference to the extent permissible.

### TECHNICAL FIELD

The present invention relates to a cutting system for a sheet of plastic material, in particular of the multilayer type and more in particular a sheet of multilayer plastic material with an alveolar sandwich structure.

### PRIOR ART

Sheets of multilayer plastic material with an alveolar sandwich structure are widely used for the formation of panels, packaging, pallets, and similar products.

Their production provides for the coupling of at least three layers, of which two external flat ones and at least an internal one with an alveolar structure. A continuous strip of material is thus produced, from which the sheets of the desired length must be singularized.

For this purpose, bladed cutting machines of two types are normally used: a shear cutting machine for low grammages of the produced material (starting for example from 100 to 200 g/m²) and a cutting machine with a blade sliding transversely to the advancement direction of the strip of material for the higher grammages. This latter cutting mode is necessary since a shear would produce an imprecise cut on a high grammage and therefore high thicknesses. Normally, a machine for cutting sheets of this type must include both types of blades, so as to be able to operate with any grammage of the material.

However, cutting systems of the known art have various drawbacks. First of all, the coexistence of the shear cutting system and the movable blade system, which operate alternatively depending on the grammage of the material, entails a considerable bulk of the machine as a whole.

Mechanical blade cutting systems also have a low operating speed, which can reach in the best case 10 linear meters per minute, but which normally settles around 3–4 linear meters per minute.

### SUMMARY OF THE INVENTION

The object of the present invention is to provide a cutting system for a sheet of multilayer plastic material, in particular multilayer plastic material with an alveolar sandwich structure, which solves the problems inherent in the conventional technique and which in particular has a reduced bulk, high productivity, and which can be used universally on all the grammages normally produced with optimal cutting precision.

Such an object is achieved by a cutting equipment.

The objects of the present description are:
1) a cutting equipment for a sheet of plastic material, in particular of the multilayer type and more in particular a sheet of multilayer plastic material with an alveolar sandwich structure, comprising a cutting member which comprises a cutting device coupled to a carriage sliding with reciprocating motion transversely to an advancement direction of a strip of said plastic material, wherein the cutting device is placed on a tiltable support and wherein the cutting device is of the ultrasonic type and comprises at least one sonotrode inclinable with respect to vertical by a predetermined angle;
2) an equipment as in point 1, comprising a first sonotrode and a second sonotrode, connected to respective piezoelectric transducers and coupled along a straight line transverse to the advancement direction of the strip of plastic material, and wherein the first and second sonotrodes are inclinable by a predetermined angle with respect to vertical and are positionable alternately so that one sonotrode is in an upper position and the other sonotrode is in a lower position, or vice versa;
3) an equipment as in point 1 or 2, wherein the tiltable support is fixed to a toothed gear with an arc of circle profile, wherein the toothed gear meshes on a rack which is moved, in a transverse direction with respect to the advancement direction of the strip of plastic material, by an actuator, such as a pneumatic actuator, and which allows the tiltable support together with the at least one sonotrode to incline in one direction or the other, preferably by an angle of between 0° and 30° with respect to vertical;
4) an equipment as in any one of points 1to 3, wherein the cutting device is placed in a casing associated with the tiltable support, and is kept abutting against a side of said casing by a safety spring element, typically a pneumatic spring, which is connectable to a position sensor;
5) an equipment as in any one of points 1 to 4, comprising a fixed base structure, a sliding surface of the sheet or strip of plastic material to be cut, the sliding surface being anchored to the base structure, and a support structure movable alternately along the advancement direction of the strip of said plastic material and placed astride the sliding surface, the support structure comprising said cutting device;
6) an equipment as in point 5, wherein the support structure comprises two side flanks and a bridge element which joins the side flanks above the sliding surface, wherein the bridge element comprises a locking member of the strip of plastic material, a cutting member for singularizing a sheet or panel from said strip of plastic material, placed downstream of the locking member and comprising said cutting device, and a retaining member for the singularized sheet, placed downstream of the cutting member;
7) an equipment as in point 6, wherein the locking member comprises a horizontal bar operatively associated with actuators, such as pneumatic jacks, adapted to move the horizontal bar vertically between a raised position of non-interference with the strip of plastic material and a lowered position of locking of the strip;
8) an equipment as in point 6 or 7, wherein the retaining member comprises a frame which supports a plurality of idle rollers, placed transversely with respect to the advancement direction of the sheet, wherein the frame is operatively connected to one or more actuators, such as pneumatic jacks, adapted to move the frame vertically between a raised position of non-interference with the sheet and a lowered retaining position, wherein the idle rollers apply a pressure to the sheet;
9) an equipment as in any one of points 1 to 8, wherein the tiltable support is coupled to a carriage, sliding on a guide transversely to the advancement direction of the strip of plastic material with a reciprocating motion, so that the carriage can make a movement between two ends of the guide either in one direction or the opposite direction;
10) an equipment as in any one of points 3 to 9, wherein the rack for tilting the tiltable support is movable between two end-of-stroke stops, adjustable so as to limit the stroke of the rack and determine the maximum inclination angle of the tiltable support;
11) an equipment as in any one of points 1 to 10, comprising a turret comprising an articulated arm which, at a distal end, carries a roller placed at a counter-roller in turn supported on the turret, wherein the roller is connected to an encoder, which controls the advancement speed of the strip of material and counts the meters of strip being processed;
12) a method of cutting a sheet or panel of plastic material, preferably multilayer plastic material with an alveolar sandwich structure, which comprises the following steps:
   a) providing a cutting equipment comprising a carriage transversely translatable with respect to the feeding direction of a strip of said material, wherein the carriage is coupled to a tiltable support which supports a first sonotrode and a second sonotrode, and wherein the first and second sonotrodes are inclinable by a predetermined angle and are positionable alternately so that one sonotrode is in an upper position and the other sonotrode is in a lower position, or vice versa;
   b) transversely translating the carriage on said strip of said material, so that the upper sonotrode performs an incision of a first portion of the strip thickness and the lower sonotrode completes the cutting of the strip;
13) a method as in point 12, wherein:
   the transverse cutting speed is up to 2200 mm/sec,
   the plastic material (M) has a grammage between 100 and 8000 g/m², and
   thicknesses up to 26 mm, the advancement speed of the strip of plastic material (M) is up to 20 linear meters per minute.

The structural and functional features of the present invention and its advantages over the known technique will become even clearer and more evident from an examination of the following description, also referring to the accompanying schematic drawings, which show an embodiment of the finding itself.

### BRIEF DESCRIPTION OF THE FIGURES

In the figures:

FIG. 1 shows a perspective view of the cutting equipment according to the invention from the entry side of the sheet;

FIG. 2 shows a front view of the equipment of FIG. 1 from the entry side of the sheet;

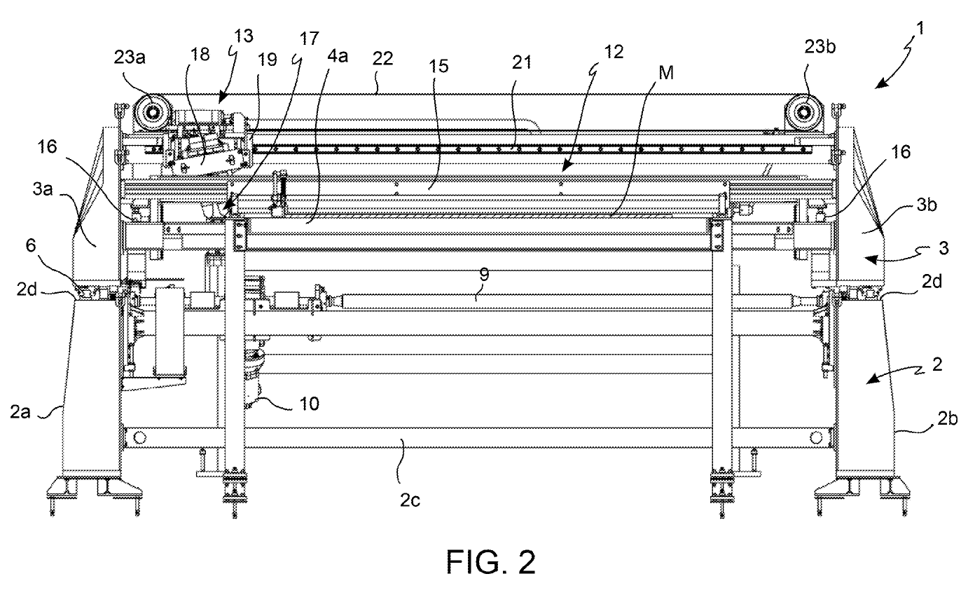

FIG. 3 shows a perspective view of the equipment of FIG. 1 from the exit side of the sheet;

FIG. 4 shows a perspective view of a detail of the equipment of FIG. 1;

FIG. 5 shows a side view of the equipment of FIG. 1;

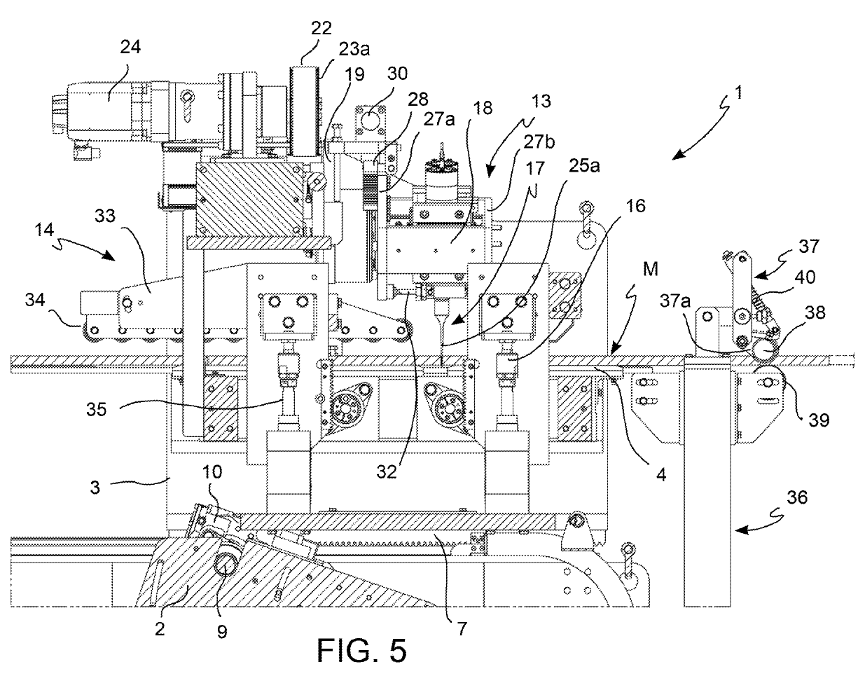

FIG. 6 shows a perspective view of a different detail of the equipment of FIG. 1;

FIG. 7 shows a perspective view of the cutting device of the equipment of FIG. 1;

FIG. 8 shows a front view of the cutting device of FIG. 7;

FIG. 9 shows a perspective view of the cutting device according to a different embodiment.

### DETAILED DESCRIPTION

In the following description, for the illustration of the figures, identical reference numbers are used to indicate constructional elements with the same function. Moreover, for clarity of illustration, some reference numbers may not have been repeated in all the figures.

Indications such as “vertical” and “horizontal”, “upper” and “lower” (in the absence of other indications) are to be read with reference to the mounting (or operational) conditions and referring to the normal terminology used in current language, where “vertical” indicates a direction substantially parallel to that of the gravitational force vector “g” and “horizontal” a direction perpendicular thereto.

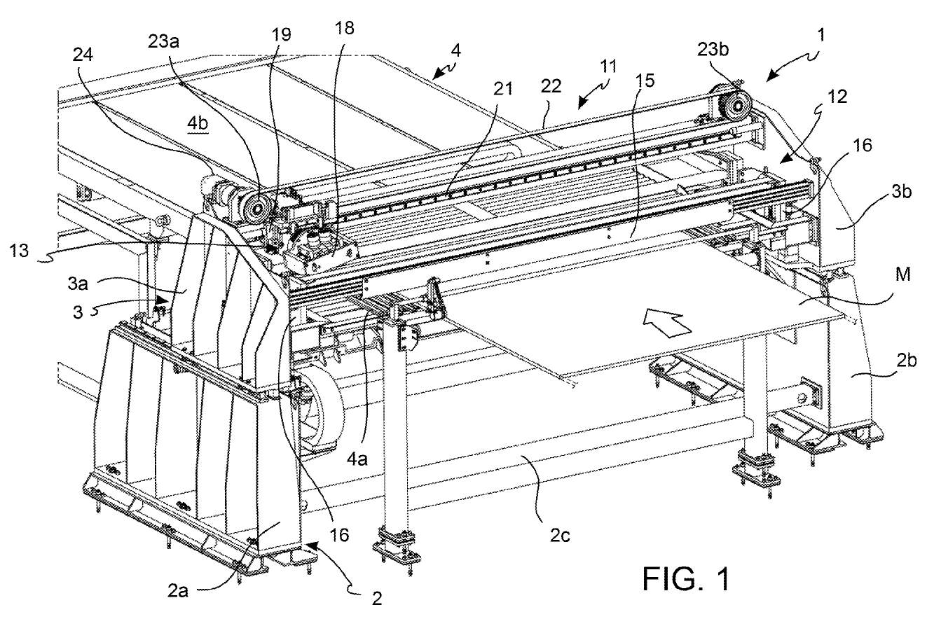

Terms such as “along the advancement direction of the sheet” or “transversely to the advancement direction of the sheet” indicate a direction of movement of one or more parts of the cutting equipment. The term “advancement direction of the sheet” refers to the direction along which the strip or sheet of material is fed to the cutting equipment, as for example indicated by the arrow in FIG. 1.

The term “sheet or panel of multilayer plastic material with alveolar sandwich structure” refers, by way of example, to a material as described in European patent No. EP1638770B1 of the same Applicant.

The term “ml/min” refers to a speed of advancement of the plastic material sheet expressed in linear meters per minute.

The cutting equipment of the invention, denoted as a whole by the number 1, comprises a fixed base structure 2, anchored to a base plane, a sliding surface 4 for a sheet or strip of plastic material M to be cut, specifically multilayer plastic material with alveolar sandwich structure, the sliding surface 4 being anchored to the base structure 2, and a movable support structure 3 placed astride the sliding surface 4.

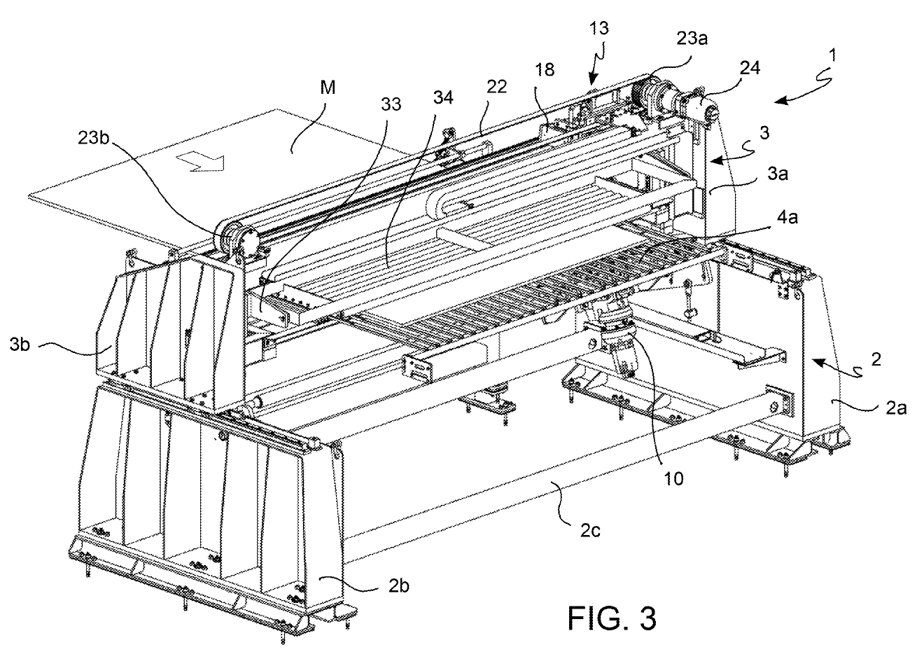

The strip of plastic material M, which in FIGS. 1 and 3 is shown interrupted upstream, but in reality is in the form of a continuous strip coming from a forming station not shown, advances on the sliding surface 4 in the direction of the arrow in FIG. 1. The sliding surface 4 comprises a first fixed section 4a, placed beneath the support structure 3, and a second section 4b formed by a conveyor adapted to remove the singularized sheet after passing through the cutting equipment 1.

The base structure 2 comprises side flanks 2a, 2b joined by bars 2c. The side flanks 2a, 2b comprise respective upper surfaces 2d on which a sliding guide 5 is placed.

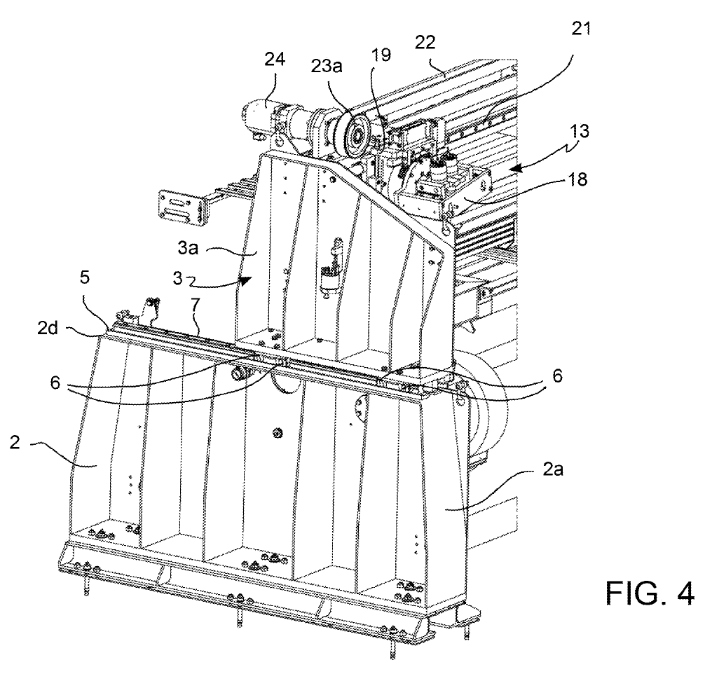

The support structure 3 in turn comprises two side flanks 3a, 3b and a bridge element 11 which joins the side flanks 3a, 3b above the first section 4a of the sliding surface 4. The support structure 3 is movable with respect to the base structure 2 along the advancement direction of the sheet by means of sliders 6 placed on said side flanks 3a, 3b and sliding along the sliding guides 5 (FIG. 4).

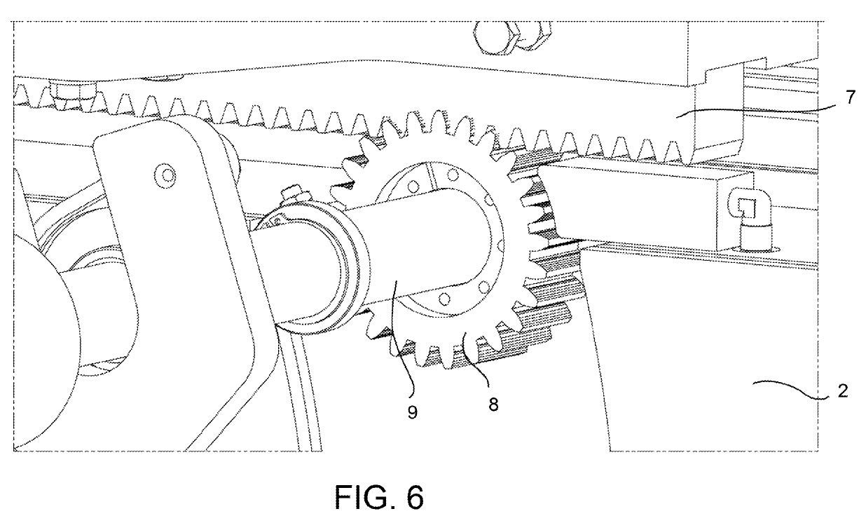

The side flanks 3a, 3b of the support structure 3 further comprise a rack 7, which meshes on a toothed wheel 8 (FIG. 6). The toothed wheel 8 is integral with a shaft 9, driven by a motor 10 adapted to reverse the direction of rotation, so that, as will be clarified below, during the operating phase of the equipment 1, the support structure 3 performs a predefined alternating movement in the advancement direction of the plastic material sheet M and in the opposite direction.

The bridge element 11 of the support structure 3 comprises a locking member 12 of the strip of plastic material M, a cutting member 13 for the singularization of a sheet or panel from said strip of plastic material M, placed downstream of the locking member 12, and a retaining member 14 for the singularized sheet, placed downstream of the cutting member 13.

The locking member 12 comprises a horizontal bar 15 operatively associated with actuators 16, such as pneumatic jacks, adapted to move the horizontal bar 15 vertically between a raised position of non-interference with the strip of plastic material M and a lowered position of locking of the strip. In the operating phase, the locking position is maintained during the movement of the support structure 3 along the advancement direction of the strip of plastic material M and in synchronization with the same, so as to “accompany” the strip, keeping it pressed against the sliding surface 4 during the transverse cutting action.

The cutting member 13 comprises a cutting device 17 placed on a tiltable support 18. The tiltable support 18 is coupled to a carriage 19, sliding, by means of a slider 20, on a guide 21 transversely to the advancement direction of the strip of plastic material M.

The carriage 19 is integral with a closed-loop belt 22, wound around two pulleys 23a, 23b, wherein one pulley 23a is operatively connected to a motor 24, while the other pulley 23b is idle. The motor 24 is configured for an alternating motion, so that the carriage can make a movement between two ends of the guide 21 either in one direction or the opposite direction.

The cutting device 17 is of the ultrasonic type and comprises at least one sonotrode 25. In a particular embodiment, the cutting device 17 comprises a first sonotrode 25a and a second sonotrode 25b, connected to respective piezoelectric transducers 26a, 26b and coupled along a straight line transverse to the advancement direction of the strip of plastic material M.

The tiltable support 18 is formed by a casing 27 which comprises a fixing side 27a to a toothed gear 28 with an arc of circle profile. The toothed gear 28 meshes on a rack 29 which is moved, in a transverse direction with respect to the advancement direction of the strip of plastic material M, by an actuator 30, such as a pneumatic actuator, between two end-of-stroke stops 31a, 31b, adjustable so as to limit the stroke of the rack 29, acting on an abutment element 29a. The rack 29, acting on the toothed gear 28 with arc of circle profile, allows the tiltable support 18 to incline in one direction or the other and the stroke of the rack 29, as adjusted by the stops 31a, 31b, determines the maximum inclination angle. As will be better described hereinafter, depending on the cases the inclination angle is generally between 0° and 30° with respect to vertical.

The cutting device 17 is placed in the casing 27 and is kept abutting against the side 27b, opposite to the aforementioned fixing side 27a, by a safety spring element 32, typically a pneumatic spring, which can be connected to a position sensor, so that, in the event of system jamming, the cutting device 17 can be released so as to avoid its breakage.

The retaining member 14 for the singularized sheet comprises a frame 33 which supports a plurality of idle rollers 34, placed transversely with respect to the advancement direction of the sheet. The frame 33 is operatively connected to one or more (for example, one on each side) actuators 35, such as pneumatic jacks, adapted to move the frame 33 vertically between a raised position of non-interference with the sheet and a lowered retaining position, wherein the idle rollers 34 apply a pressure on the sheet to prevent it from misaligning with respect to the advancement direction.

In certain embodiments, upstream of the entry of the strip of plastic material M onto the sliding surface 4, a turret 36 is placed comprising an articulated arm 37 which carries at a distal end 37a a roller 38 placed at a counter-roller 39 in turn supported on the turret 36. The roller 38 is kept in contact with the strip of material passing between roller 38 and counter-roller 39 by elastic means 40 acting on the articulated arm 37 and is connected with an encoder, which controls the advancement speed of the strip of material and counts the meters of strip being processed.

The operation of the cutting equipment 1 is described below.

At start-up, when the strip of plastic material M is introduced into the cutting equipment 1, it advances for a predefined stretch depending on the length of the sheet or panel to be produced. At this point, the strip is locked by the locking member 12 upstream of the cutting member 13 and, substantially at the same time, by the retaining member 14 of the sheet downstream of the cutting member 13.

Simultaneously, the support structure 3 translates on the base structure 2 with a motion synchronized with the feed speed of the material strip, so as to accompany it during the operation and avoid a discontinuous stop-and-start system.

During the longitudinal translation of the support structure 3, the carriage 19 of the cutting member 13 performs a transverse translation from one end to the other of the guide 21. During this transverse translation, the at least one sonotrode 25, 25a, 25b of the cutting device 17 performs the cutting of the sheet as follows.

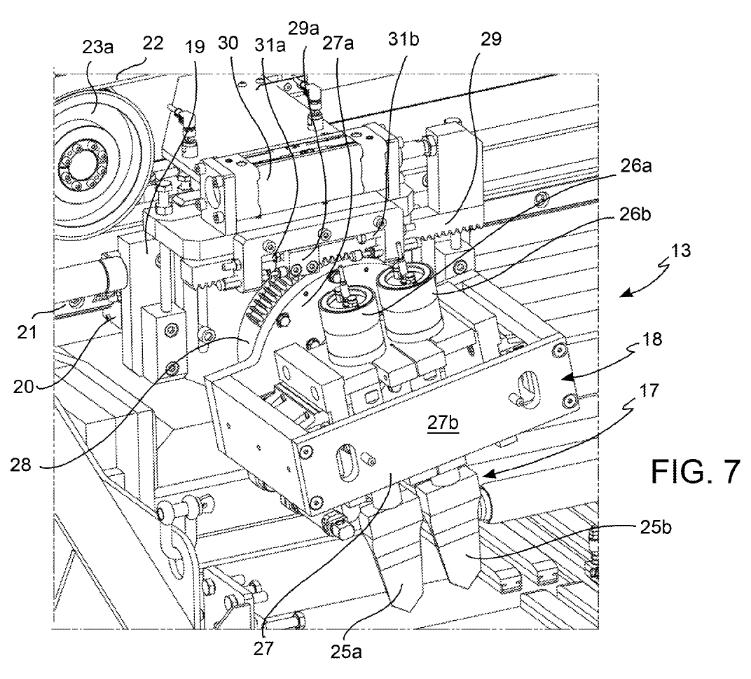

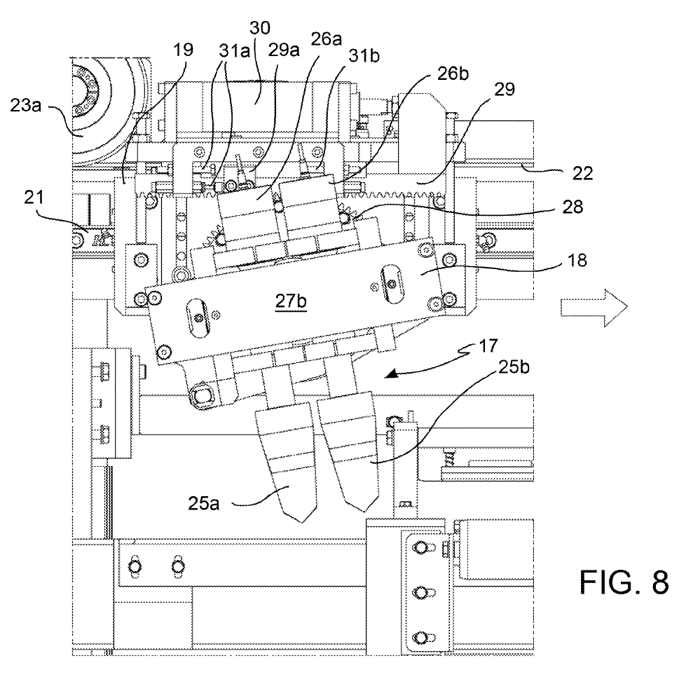

According to the embodiment shown in FIGS. 7 and 8, the tiltable support 18 is inclined so that one sonotrode, for example the second sonotrode 25b, is in an upper position with respect to the first sonotrode 25a. The arrow in FIG. 8 shows the direction of translation of the carriage 19, so that the upper sonotrode 25b performs a first cut, while the lower sonotrode 25a, which operationally follows the upper sonotrode 25b, completes the cutting of the sheet. This mode allows even a sheet of considerable thickness to be cut quickly and precisely, since the upper sonotrode 25b, acting on the outer surface, incises a first half of the sheet thickness; the lower sonotrode 25a, on the other hand, being positioned substantially in contact with the bottom of the incision, completes the cutting of the remaining thickness. The inclination of the tiltable support 18, which determines the height difference between the two sonotrodes 25a, 25b, is adjusted based on the thickness of the sheet to be cut: for sheets of reduced thickness, the angle with respect to vertical, which as stated can vary between 0° and 30°, will have a lower value, which instead will increase for greater thicknesses.

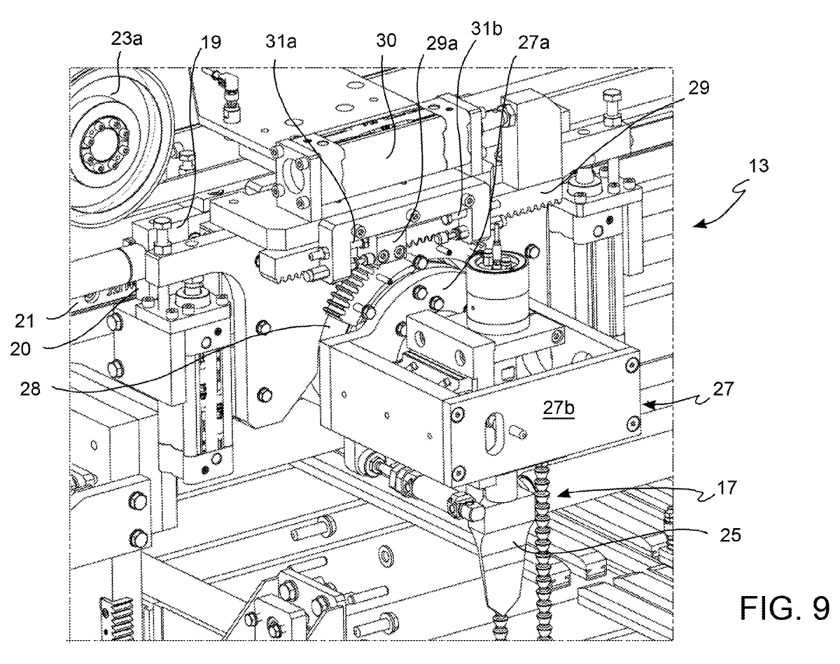

In the embodiment of FIG. 9, comprising only one sonotrode 25, the cut is performed directly by the single sonotrode, but in this case the delivered power will be higher and/or the translation speed lower than in the solution with two sonotrodes. It has nonetheless been observed that the inclination of the sonotrode 25, which determines an angle of incidence with the surface to be cut, is advantageous in terms of cutting efficiency and quality compared to a cut perpendicular to the surface.

In this embodiment, it may also be possible to maintain the same power and cutting speed as in the version with two sonotrodes, but performing a double pass of the cutting device, i.e., moving it transversely first in one direction, then in the opposite direction and adapting accordingly the inclination of the tiltable support 18.

Once the cut has been completed and thus the sheet singularized, the latter is held in position by the retaining member 14 and conveyed onto a downstream conveyor (section 4b), while the locking member 12 is released so as to advance another stretch of continuous strip, and the support structure 3 is moved back to the initial position, after which the operation is repeated. In this case, however, as the carriage 19 is positioned at the opposite end of the guide 21, the tiltable support 18 is inclined in the opposite direction, so that, with reference to the figures, the first sonotrode 25a (which was previously in the lower position) becomes the upper sonotrode and the second sonotrode 25b becomes the lower sonotrode. In this way, the first incision of the sheet is performed by the first sonotrode 25a and the completion of the cut by the second sonotrode 25b. The same inversion of inclination of the tiltable support 18 will also be applied in the embodiment of FIG. 9.

As previously mentioned, the inclination adjustment is performed by means of the end-of-stroke stops 31a, 31b, which limit the movement of the rack 29.

It is therefore a further object of the present invention a method of cutting a sheet or panel of plastic material M, preferably multilayer plastic material with alveolar sandwich structure, comprising the following steps:
a) providing a cutting equipment comprising a carriage 19 transversely translatable with respect to the feeding direction of a strip of said material, wherein the carriage 19 is coupled to a tiltable support 18 which supports a first sonotrode 25a and a second sonotrode 25b, and wherein the first and second sonotrodes 25a, 25b are inclinable by a predetermined angle and are positionable alternately so that one sonotrode 25a is in an upper position and the other sonotrode 25b is in a lower position, or vice versa;
b) transversely translating the carriage 19 on said strip of said material, so that the upper sonotrode 25a or 25b performs an incision of a first portion of the strip thickness and the lower sonotrode 25b or 25a completes the cutting of the strip.

Thanks to the above-described cutting system, the cutting equipment 1 of the invention allows to achieve high transverse cutting speeds, up to 2200 mm/sec, and the cutting of panels over a wide range of grammages, i.e., with grammage between 100 and 8000 g/m², and with thicknesses up to 26 mm.

Furthermore, a high productivity of the equipment is achieved compared to known solutions, reaching an advancement speed of the strip of plastic material M up to 20 ml/min, compared to the maximum speed of 10 ml/min of state-of-the-art machines.

It is evident that only some particular embodiments of the present invention have been described, to which the person skilled in the art will be able to make all those modifications necessary for its adaptation to particular applications, without however departing from the scope of protection of the present invention as defined in the appended claims.

1. A cutting equipment for a sheet of plastic material, comprising a cutting member, which comprises a cutting device coupled to a carriage sliding with reciprocating motion transversely to an advancement direction of a strip of said plastic material, wherein the cutting device is placed on a tiltable support wherein the cutting device is an ultrasonic cutting device and comprises at least one sonotrode inclinable by a predetermined angle with respect to vertical.

2. The equipment according to claim 1, comprising a first sonotrode and a second sonotrode, connected to respective piezoelectric transducers and coupled along a straight line transverse to the advancement direction of the strip of plastic material, and wherein the first and second sonotrodes are inclinable by a predetermined angle and are positionable alternately so that one sonotrode is in an upper position and the other sonotrode is in a lower position, or vice versa.

3. The equipment according to claim 1, wherein the tiltable support is fixed to a toothed gear with an arc of circle profile, wherein the toothed gear meshes on a rack which is moved, in a transverse direction with respect to the advancement direction of the strip of plastic material, by an actuator, and which allows the tiltable support together with the at least one sonotrode to incline in one direction or the other.

4. The equipment according to claim 1, wherein the cutting device is placed in a casing associated with the tiltable support and is kept abutting against a side of said casing by a safety spring element which is connectable to a position sensor.

5. The equipment according to claim 1, comprising a fixed base structure, a sliding surface of the sheet or strip of plastic material to be cut, the sliding surface being anchored to the base structure, and a support structure movable alternately along the advancement direction of the strip of said plastic material and placed astride the sliding surface, the support structure comprising said cutting device.

6. The equipment according to claim 5, wherein the support structure comprises two side flanks and a bridge element which joins the side flanks above the sliding surface, wherein the bridge element comprises a locking member of the strip of plastic material, a cutting member for singularizing a sheet or panel from said strip of plastic material, placed downstream of the locking member and comprising said cutting device, and a retaining member for the singularized sheet, placed downstream of the cutting member.

7. The equipment according to claim 6, wherein the locking member comprises a horizontal bar operatively associated with actuators, adapted to move the horizontal bar vertically between a raised position of non-interference with the strip of plastic material and a lowered position of locking of the strip.

8. The equipment according to claim 6, wherein the retaining member comprises a frame which supports a plurality of idle rollers, placed transversely with respect to the advancement direction of the sheet, wherein the frame is operatively connected to one or more actuators, adapted to move the frame vertically between a raised position of non-interference with the sheet and a lowered retaining position, where the idle rollers apply a pressure to the sheet.

9. The equipment according to claim 1, wherein the tiltable support is coupled to a carriage, sliding on a guide transversely to the advancement direction of the strip of plastic material with a reciprocating motion, so that the carriage is moveable between two ends of the guide either in one direction or an opposite direction.

10. The equipment according to claim 3, wherein the rack for tilting the tiltable support is movable between two end-of-stroke stops, adjustable to limit a stroke of the rack and determine the maximum inclination angle of the tiltable support.

11. The equipment according to claim 1, comprising a turret comprising an articulated arm which, at a distal end, carries a roller placed at a counter-roller supported on the turret, wherein the roller is connected to an encoder, which controls the advancement speed of the strip of material and counts the meters of strip being processed.

12. The equipment according to claim 1, wherein the tiltable support is fixed to a toothed gear with an arc of circle profile, wherein the toothed gear meshes on a rack which is moved, in a transverse direction with respect to the advancement direction of the strip of plastic material, by a pneumatic actuator, and which allows the tiltable support together with the at least one sonotrode to incline in one direction or the other by an angle of between 0° and 30° with respect to vertical.

13. The equipment according to claim 1, wherein the tiltable support is fixed to a toothed gear with an arc of circle profile, wherein the toothed gear meshes on a rack which is moved, in a transverse direction with respect to the advancement direction of the strip of plastic material, by a pneumatic actuator, and which allows the tiltable support together with the at least one sonotrode to incline in one direction or the other.

14. The equipment according to claim 6, wherein the locking member comprises a horizontal bar operatively associated with actuators comprising pneumatic jacks, adapted to move the horizontal bar vertically between a raised position of non-interference with the strip of plastic material and a lowered position of locking of the strip.

15. The equipment according to claim 6, wherein the retaining member comprises a frame which supports a plurality of idle rollers, placed transversely with respect to the advancement direction of the sheet, wherein the frame is operatively connected to one or more actuators comprising pneumatic jacks, adapted to move the frame vertically between a raised position of non-interference with the sheet and a lowered retaining position, where the idle rollers apply a pressure to the sheet.

16. The equipment according to claim 1, wherein the cutting device is placed in a casing associated with the tiltable support, and is kept abutting against a side of said casing by a safety spring element comprising a pneumatic spring, which is connectable to a position sensor.

17. A method of cutting a sheet or panel of plastic material, the method comprising the following steps:
a) providing a cutting equipment comprising a carriage transversely translatable with respect to the feeding direction of a strip of said material, wherein the carriage is coupled to a tiltable support which supports a first sonotrode and a second sonotrode, and wherein the first and second sonotrodes are inclinable by a predetermined angle and are positionable alternately so that one sonotrode is in an upper position and the other sonotrode is in a lower position, or vice versa;
b) transversely translating the carriage on said strip of said material, so that the upper sonotrode makes an incision of a first strip thickness portion and the lower sonotrode completes cutting of the strip.

18. The method according to claim 17, wherein:
a transverse cutting speed is up to 2200 mm/sec;
the plastic material has a weight between 100 and 8000 g/m² and thicknesses up to 26 mm,
an advancement speed of the strip of plastic material is up to 20 linear meters per minute.

19. The method according to claim 17, wherein the sheet or panel comprises a sheet or panel of multilayer plastic material with an alveolar sandwich structure.

20. A cutting equipment for a sheet of multilayer plastic material with an alveolar sandwich structure, comprising a cutting member, which comprises a cutting device coupled to a carriage sliding with reciprocating motion transversely to an advancement direction of a strip of said plastic material, wherein the cutting device is placed on a tiltable support wherein the cutting device is an ultrasonic cutting device and comprises at least one sonotrode inclinable by a predetermined angle with respect to vertical.
